(19) United States
(12) Patent Application Publication
(10) Pub. No.: US 2013/0179801 A1
(43) Pub. Date: Jul. 11, 2013

(54) METHOD OF ASSOCIATING ATTRIBUTES AND SYSTEMS AND APPARATUS THEREOF

(71) Applicants: Mathieu Audet, Montreal (CA); Yves Berthiaume, Granby (CA)

(72) Inventors: Mathieu Audet, Montreal (CA); Yves Berthiaume, Granby (CA)

(21) Appl. No.: 13/737,767

(22) Filed: Jan. 9, 2013

Related U.S. Application Data
(60) Provisional application No. 61/585,000, filed on Jan. 10, 2012.

(51) Int. Cl. H04L 12/58

(52) U.S. Cl. CPC H04L 51/00
USPC 715/752

(57) ABSTRACT

Is provided herein a method of automatically associating attributes with email attachments and graphically displaying the email with respective attachments in a generally rectilinear fashion and in graphical relationship. Emails and attachments are also separated, sorted and displayed in conjunction with other documents having at least one commonality.

### CROSS REFERENCE TO RELATED APPLICATIONS

The present application is a non-provisional of, and claims priority under 35 U.S.C. 119(e) to, U.S. provisional application No. 61/585,000, entitled AUTOMATIC ATTRIBUTE ASSOCIATION AND COMPUTING TIME REDUCTION, filed on Jan. 10, 2012, which is herein incorporated by reference in its entirety. Any publication of and any patent issuing from the foregoing U.S. patent applications are hereby incorporated herein by reference.

### FIELD OF THE INVENTION

This invention relates generally to computer systems and more specifically to a method, a system and an interface that facilitates the association of attributes with documents and the reduction of computing time. More precisely, the present invention relates to a method of automatically associating attributes with e-mails' attachments and a method for computing time reduction.

### BACKGROUND OF THE INVENTION

E-mail communications have become an extremely important aspect of intra and extra enterprise communications, becoming, in some circles, more important than all other means of communications combined.

The volume of data that transits through e-mail software systems has therefore become quite huge, and increasingly difficult to handle properly.

E-mail software systems typically allow the user to “store” or “archive” incoming or outgoing e-mails; in some businesses, it is actually mandatory to periodically go through a storage exercise, for server memory space considerations.

In view of the prior art it appears that improvements over the prior art is desirable to improve the user experience and usability either with innovative functional improvements.

### SUMMARY OF THE INVENTION

It is one aspect of the present invention to alleviate one or more of the shortcomings of background art by addressing one or more of the existing needs in the art.

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

At least one aspect of the invention provides a method to associate e-mails with attributes to facilitate management of a significant number of e-mails, in accordance with at least one embodiment.

At least one aspect of the invention provides a method to associate e-mails with attributes to reduce the number of actions to properly classify, and later retrieve, each e-mail, in accordance with at least one embodiment.

At least one aspect of the invention provides a method to separate e-mails into various portions and associate each portion with a respective attribute, in accordance with at least one embodiment.

At least one aspect of the invention provides a method to associate e-mails with its attachment to allow separate classification of the attachments, in accordance with at least one embodiment.

At least one aspect of the invention provides a method to display e-mails with associated attachments to facilitate relative visualization, when required, of the attachment with its associated e-mail, in accordance with at least one embodiment.

At least one aspect of the invention provides a method to display e-mails with associated attachments along a substantially rectilinear layout to facilitate relative visualization thereof of the attachment with its associated e-mail, in accordance with at least one embodiment.

At least one aspect of the invention provides a method to include e-mails, with associated attachments, on axes with other documents to facilitate relative visualization, when required, of the e-mails, with associated attachments, among other types of documents, in accordance with at least one embodiment.

At least one aspect of the invention provides a method to separate calendar events into various portions and associate each portion with a respective attribute, in accordance with at least one embodiment.

At least one aspect of the invention provides a method to associate calendar events with its attachment to allow separate classification of the attachments, in accordance with at least one embodiment.

At least one aspect of the invention provides a method to present and display e-mails, contacts, calendar events along a same axis when they all relate to a same attributes in order to facilitate relative visualization various types of information in a uniformed axial layout, in accordance with at least one embodiment.

At least one aspect of the invention provided a method to present information elements with a marker to let the user know of the existence of attachments, in accordance with at least one embodiment.

Other advantages might become apparent to the skilled reader of this patent specification in light of the text and appended drawings.

### BRIEF DESCRIPTION OF THE DRAWINGS

FIG. 1 is a schematic illustration of an exemplary network;

FIG. 2 is a schematic illustration of an alternate exemplary network;

FIG. 3 is a schematic illustration of an exemplary computer system;

FIG. 4 is a schematic illustration of an exemplary software system;

FIG. 5 is a schematic illustration of an axis-based interface and operating system;

FIG. 6 is a schematic illustration of an exemplary axis layout;

FIG. 7 is a schematic illustration of exemplary axes layout;

FIG. 8 is a schematic illustration of a list and a tree-based, multi-level structure of documents;

FIG. 9 is a schematic illustration of a graph;

FIG. 10 is a schematic illustration of a list of e-mails documents;

FIG. 11 is a schematic illustration of a graph;

FIG. 12 is a schematic illustration of a list and a tree-based, multi-level structure of documents;

FIG. 13 is a schematic illustration of an e-mail document structure in accordance of the present invention;

FIG. 14 is a schematic illustration of an e-mail document structure in accordance of the present invention;

FIG. 15 is a schematic illustration of an e-mail document structure in accordance of the present invention;

FIG. 16 is a schematic illustration of an e-mail document structure in accordance of the present invention;

FIG. 17 is a schematic illustration of an e-mail and an information element in accordance of the present invention;

FIG. 18 is a schematic illustration of an e-mail and multiple information element in accordance of the present invention;

FIG. 19 is a schematic illustration of an e-mail and multiple information element in accordance of the present invention;

FIG. 20 is a schematic illustration of an exemplary axis in accordance of the present invention;

FIG. 21 is a schematic illustration of two exemplary axes in accordance of the present invention;

FIG. 22 is a schematic illustration of a calendar event and an information element in accordance of the present invention;

FIG. 23 is a schematic illustration of a calendar event and an information element in accordance of the present invention;

FIG. 24 is a schematic illustration of a calendar event and an information element in accordance of the present invention;

FIG. 25 is a schematic illustration of an exemplary axis in accordance of the present invention;

FIG. 26 is a schematic illustration of two exemplary axes in accordance of the present invention;

FIG. 27 is a flow chart describing the method of separating e-mail from its attachments and associating attributes on them, in accordance of the present invention.

### DESCRIPTION OF EMBODIMENT(S) OF THE INVENTION

Our work is now described with reference to the figures. In the following description, for purposes of explanation, numerous specific details are set forth in order to provide a thorough understanding of the present invention by way of embodiment(s). It may be evident, however, that the present invention may be practiced without these specific details. In other instances, when applicable, well-known structures and devices are shown in block diagram form in order to facilitate describing the present invention.

The features provided in this specification mainly but might not exclusively relate to principles of computer software and machine-readable code/instructions adapted to instruct a computer, many computers or other machines adapted to use the instructions to provide material effects on a display, or other means enabling human-computer interactions to manage documents, menus, user-selectable elements and other computer files. These code/instructions are preferably stored on a machine-readable medium to be read and acted upon with a computer or machine having the appropriate code/instructions reading capability.

### Exemplary Network

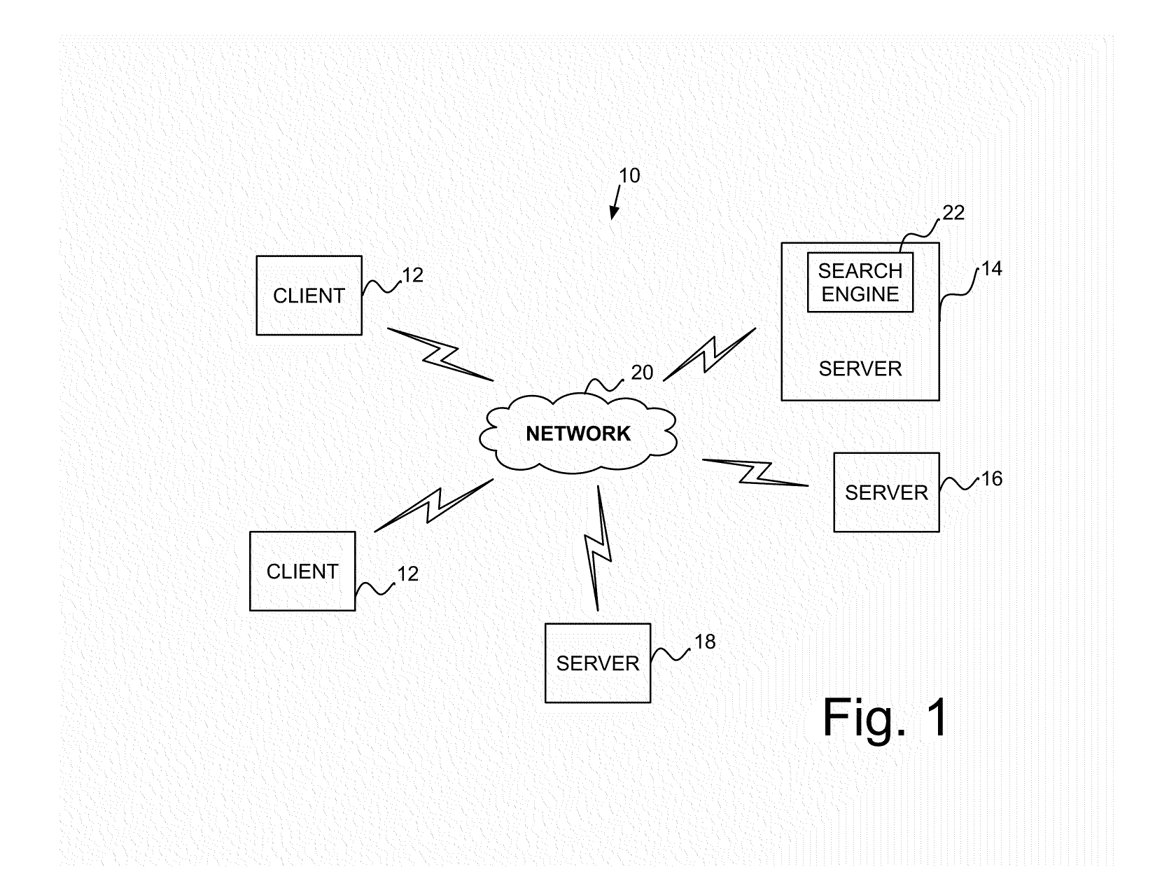

FIG. 1 illustrates an exemplary network 10 in which a system and a method, consistent with the present invention, may be implemented. The network 10 may include multiple client devices 12 connected to multiple servers 14, 16, 18 via a network 20. The network 20 may include a local area network (LAN), a wide area network (WAN), a phone network, such as the Public Switched Phone Network (PSTN), an intranet, the Internet, Wi-Fi, WiMAX or a combination thereof. Two client devices 12 and three servers 14, 16, 18 have been illustrated as connected to network 20 for simplicity. In practice, there may be more or less client devices and servers 14, 16, 18. Also, in some instances, a client 12 device may perform the functions of a server 14, 16, 18 and a server 14, 16, 18 may perform the functions of a client 12 device.

The client devices 12 may include devices such as mainframes, minicomputers, personal computers, laptops, personal digital assistants, phones, or the like, capable of connecting to the network 20. The client devices 12 may transmit data over the network 20 or receive data from the network 20 via a wired, wireless, or optical connection.

The servers 14-18 may include one or more types of computer systems, such as a mainframe, minicomputer, or personal computer, capable of connecting to the network 20 to enable servers 14-18 to communicate with the client devices 12. In alternative implementations, the servers 14-18 may include mechanisms for directly connecting to one or more client devices 12. The servers 14-18 may transmit data over the network 20 or receive data from the network 20 via a wired, wireless, or optical connection.

In an implementation consistent with the present invention illustratively embodied herein, the servers 14-18 may include a search engine 22 usable by the client devices 12. The servers 14-18 may store documents 200, such as web pages, accessible by the client devices 12.

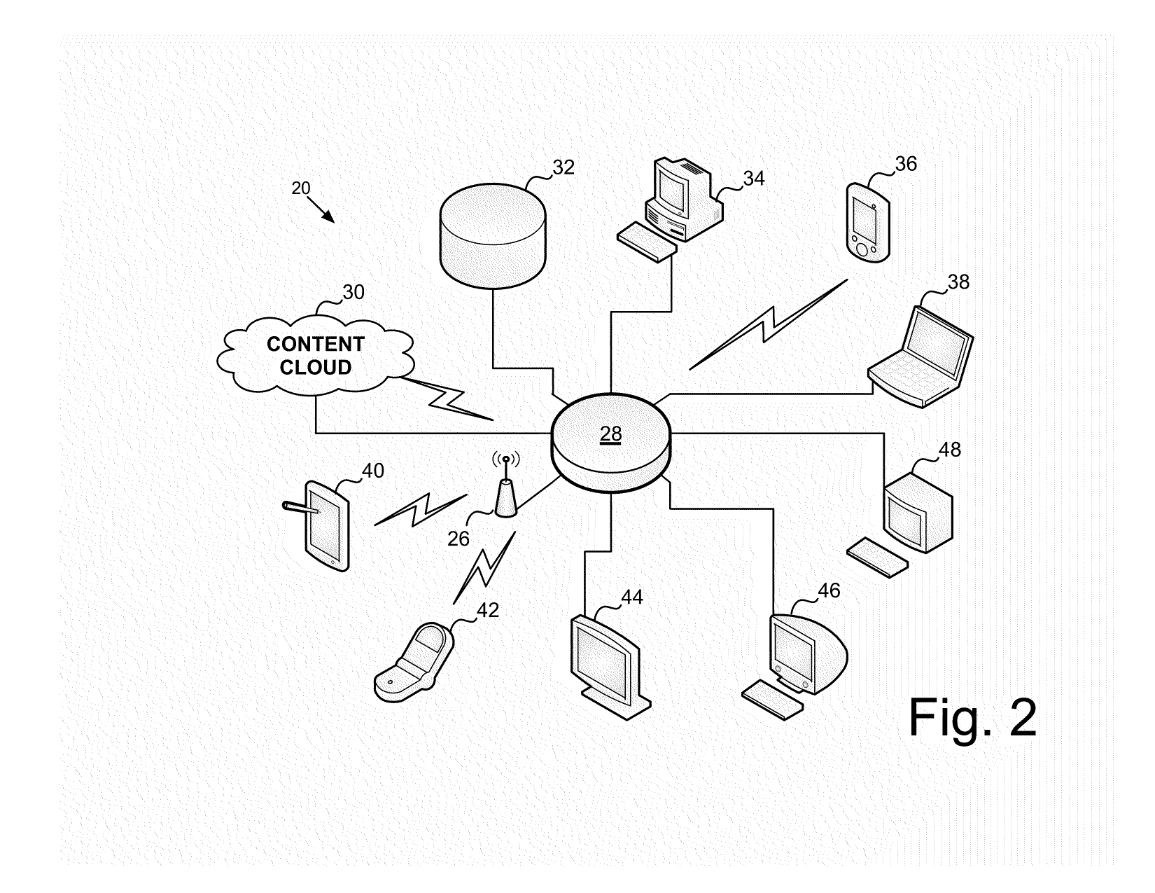

With reference to FIG. 2, a network 20 includes the content cloud 30, a content database 32, content devices 34-38, and other devices 40-48. The network mediator 28 enables network devices 34-48 to communicate with each other without pre-configuring each device 34-48. The content cloud 30 represents a content source such as the Internet, where content exists at various locations across the globe that could be reached through a wired connection and/or with a wireless connection provided by an antenna 26. The content includes multimedia content such as audio and video. The mediator 28 allows the content cloud to provide content to devices 34-48. The database 32 is a storage device 166 that maintains content. The database 32 may be a standalone device on an external communication network. The mediator 28 communicates with the database 32 to access and retrieve content. The content devices 34-48 include intelligent devices, such as, for example, personal computers, laptops, cell phones and personal digital assistants. The content devices 34-48 are capable or storing content data. The devices 34-48 are intelligent devices that receive content from other content devices 30-48. However, the devices 34-48 can also operate as servers to distribute content to other client devices if desirable.

### Exemplary Client Architecture

The following discussion provides a brief, general description of an exemplary computer apparatus in which at least some aspects of the present invention may be implemented. The present invention will be described in the general context of computer-executable instructions, such as program modules 174 being executed by a computerized device. However, methods of the present invention may be affected by other apparatuses. Program modules may include routines, programs, objects, components, data structures, applets, WEB 2.0 type of evolved networked centered applications, etc. that perform a task(s) or implement particular abstract data types. Moreover, those skilled in the art will appreciate that at least some aspects of the present invention may be implemented with other configurations, including hand-held devices, multiprocessor system, microprocessor-based or programmable consumer electronics, network computers, minicomputers, set top boxes, mainframe computers, gaming consoles and the like. At least some aspects of the present invention may also be carried out in distributed computing environments where tasks are performed by remote processing devices linked through a communications network as exemplified in FIG. 2. In a distributed computing environment, program modules 174 may be located in local and/or remote memory storage devices 166.

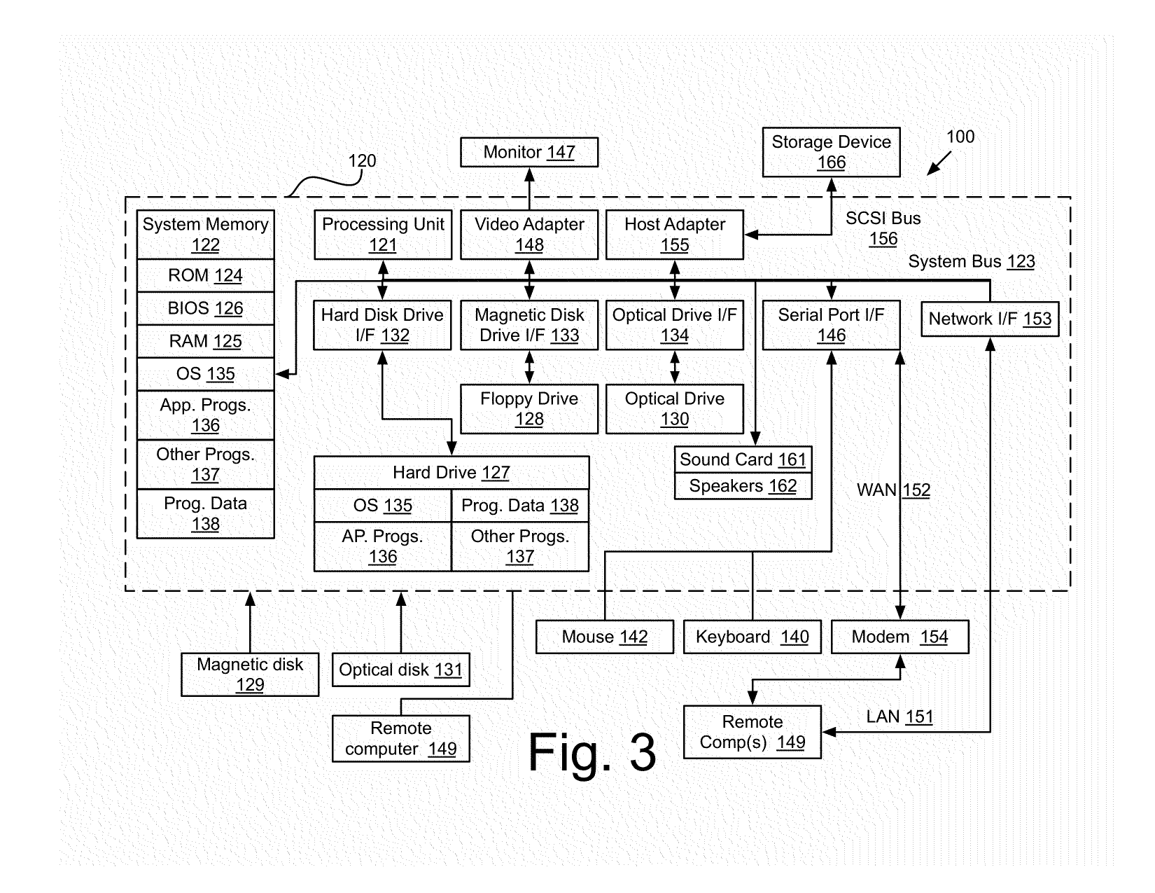

With reference to FIG. 3, an exemplary apparatus 100 for implementing at least some aspects of the present invention includes a general-purpose computing device in the form of a computer 120 or in the form of a computerized portable apparatus. The computer 120 may include a processing unit 121, a system memory 122, and a system bus 123 that couples various system components, including the system memory 122, to the processing unit 121. The system bus 123 may be any of several types of bus structures including a memory bus or memory controller, a peripheral bus, and a local bus using any of a variety of bus architectures. The system memory may include read only memory (ROM) 124 and/or random access memory (RAM) 125. A basic input/output system 126 (BIOS), containing basic routines that help to transfer data between elements within the computer 120, such as during start-up, may be stored in ROM 124. The computer 120 may also include a hard disk drive 127 for reading from and writing to a hard disk, (not shown), a magnetic disk drive 128 for reading from or writing to a (e.g., removable) magnetic disk 129, and an optical disk drive 130 for reading from or writing to a removable (magneto) optical disk 131 such as a compact disk or other (magneto) optical media. The hard disk drive 127, magnetic disk drive 128, and (magneto) optical disk drive 130 may be coupled with the system bus 123 by a hard disk drive interface 132, a magnetic disk drive interface 133, and a (magneto) optical drive interface 134, respectively. The drives and their associated storage media provide non-volatile (or persistent) storage of machine-readable instructions, data structures, program modules 174 and other data for the computer 120. Although the exemplary environment described herein employs a hard disk, a removable magnetic disk 129 and a removable optical disk 131, those skilled in the art will appreciate that other types of storage media, such as magnetic cassettes, flash memory cards, digital video disks, Bernoulli cartridges, random access memories (RAMs), read only memories (ROM), remote cloud storage and the like, may be used instead of, or in addition to, the storage devices 166 introduced above.

A number of program modules 174 may be stored on the hard disk 127, magnetic disk 129, (magneto) optical disk 131, ROM 124 or RAM 125, such as an operating system 135 (for example, Windows® NT® 4.0, sold by Microsoft® Corporation of Redmond, Wash.), one or more application programs 136, other program modules 137 (such as Alice™, which is a research system developed by the User Interface Group at Carnegie Mellon University available at www.Alice.org, OpenGL® from Silicon Graphics Inc. of Mountain View Calif., or Direct 3D from Microsoft Corp. of Bellevue Wash.), and/or program data 138 for example.

A user may enter commands and data into the computer 120 through input devices, such as a keyboard 140, a camera 141 and a pointing device 142 Other input devices (not shown) such as a microphone, joystick, game pad, satellite dish, scanner, a touch sensitive screen, accelerometers or a motion-sensor detector such as KINECT™ that are adapted to sense movements of the user or movements of a device, or the like, may also be included. These and other input devices are often connected to the processing unit 121 through a serial port interface 146 coupled to the system bus 123. However, input devices may be connected by other interfaces, such as a parallel port, a game port, blue tooth connection or a universal serial bus (USB). For example, since the bandwidth of the camera 141 may be too great for the serial port, the video camera 141 may be coupled with the system bus 123 via a video capture card (not shown). The video monitor 147 or other type of display device 150 may also be connected to the system bus 123 via an interface, such as a video adapter 148 for example. The video adapter 148 may include a graphics accelerator. One or more speakers 162 may be connected to the system bus 123 via a sound card 161 (e.g., a wave table synthesizer such as product number AWE64 Gold Card from Creative® Labs of Milpitas, Calif.). In addition to the monitor 147 and speaker(s) 162, the computer 120 may include other peripheral output devices (not shown), such as a printer, a hi-definition television and a scanner for example. As an alternative or an addition to the video monitor 147, a stereo video output device, such as a head mounted display or LCD shutter glasses for example, could be used.

The computer 120 may operate in a networked environment defining logical connections to one or more remote computers 120, such as a remote computer 149. The remote computer 149 may be another computer 120, a server 14-18, a router, a network PC, a peer device or other common network node, and may include many or all of the elements described above relative to the computer 120. The logical connections depicted in FIG. 3 include a local area network (LAN) 151 and a wide area network (WAN) 152, an intranet and the Internet.

When used in a LAN, the computer 120 may be connected to the LAN 151 through a network interface adapter (or “NIC”) 153. When used in a WAN, such as the Internet, the computer 120 may include a modem 154 or other means for establishing communications over the wide area network 152 (e.g. Wi-Fi, WinMax). The modem 154, which may be internal or external, may be connected to the system bus 123 via the serial port interface 146 or another type of port interface. In a networked environment, at least some of the program modules depicted relative to the computer 120 may be stored in the remote memory storage device 166. The network connections shown are exemplary and other means of establishing a communications link between the computers 120 may be used.

The exemplary network and the exemplary computer system described above are adapted to carry on the following embodiments:

### The System

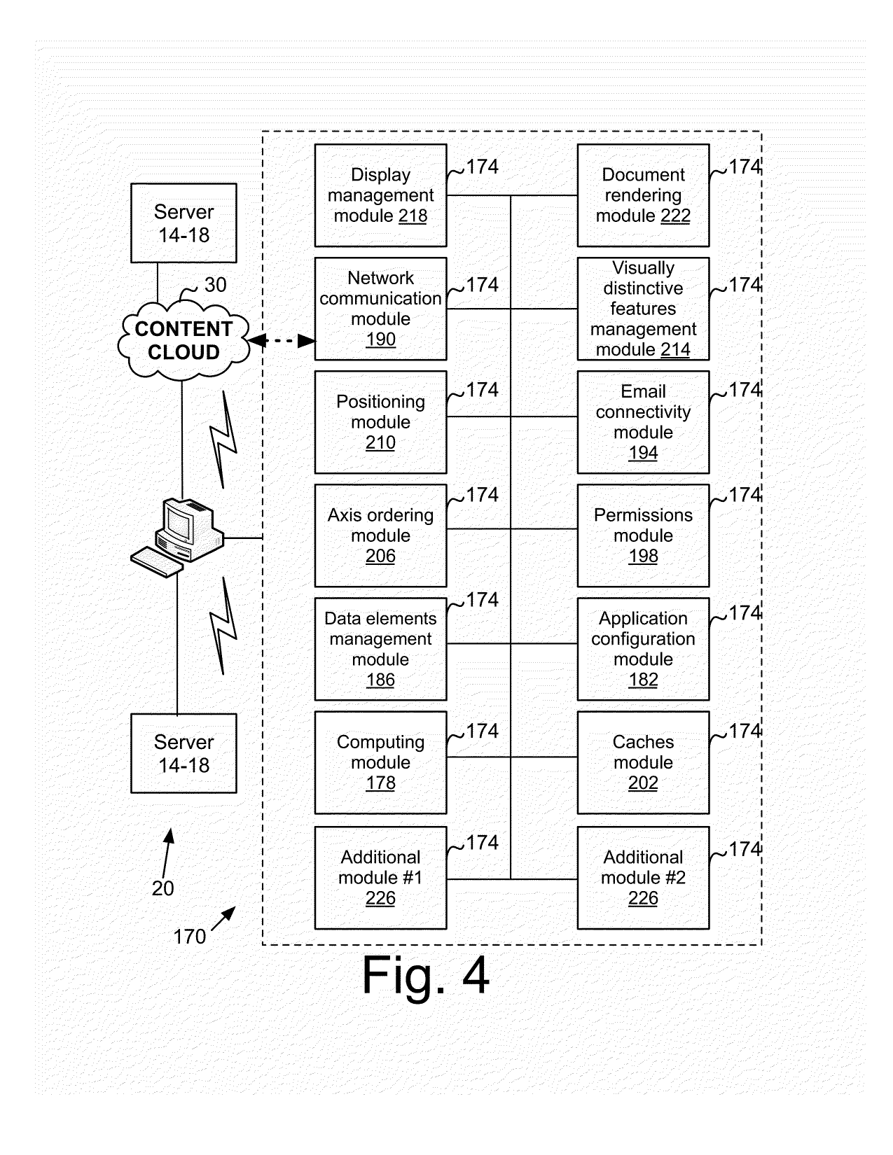

A system 170 is depicted in FIG. 4 which may represent the functionalities described in the instant application when run on an apparatus 100, for instance a computer 120, such as has been previously described. The computer 120 may in turn be connected to a server 14-18 comprising a set of program modules 174 enabling functions including but not limited to: computing, document rendering, network communication, application configuration and local database management.

The software system 170 illustratively consists of a collection of at least twelve modules 174 independent from those of the server 14-18 that together carry out the method required for the functionalities to be visible on a graphical user interface and usable by the user. As illustrated, additional modules 226 may also be used in conjunction with the twelve base modules.

A computing module 178 provides a means to circulate data between users, the other modules 174 and the apparatus 100. The computing module 178 is adapted to convert queries 230, which may be system-based or user-based, into graphical rendering in accordance with at least one embodiment of the present invention. The other modules 174 are configured to send to and receive data from the computing module and to individually or collectively interact with other modules 174.

An application configuration module 182 provides software configuration to manage application settings and open connections to other servers 14-18. Other modules 174 may use the application configuration module 182 to manage their behavior to satisfy user-specific needs.

A data elements management module 186 may be used in conjunction with other modules to manage data elements such as documents 200 contained in a database 32 in response to a query 230. The data elements management module 186 may use any kind of database connection and may use a network communication module 190 in order to access a database 32 through a network 28, on a server computer 14-18. The network communication module 190 may use several protocols in order to communicate with a server computer 14-18, such as IPv4, IPv6, TCP, UDP, ODBC, HTTP, WebDAV, SSH, IMAP and even define its own specific communication protocol. The data elements management module 186 may also be used in conjunction with an email connectivity module 194 and network communication module 190 in order to treat and represent emails in the same way as the data elements of a database 32. The data elements management module 186 may also be used in conjunction with the permissions module 198 (on the client or server side) in order to control the user access to elements based by some sort of sharing rules. The data elements management module 186 may also work in conjunction with a caches module 202, providing client-side cached versions of the database 32 and files in order to respond to future requests faster. Modules 174 may be made to communicate information in a standardized way by the use of an Application Programming Interface (API) in order to simplify the data elements management module's 186 interactions with other modules 174.

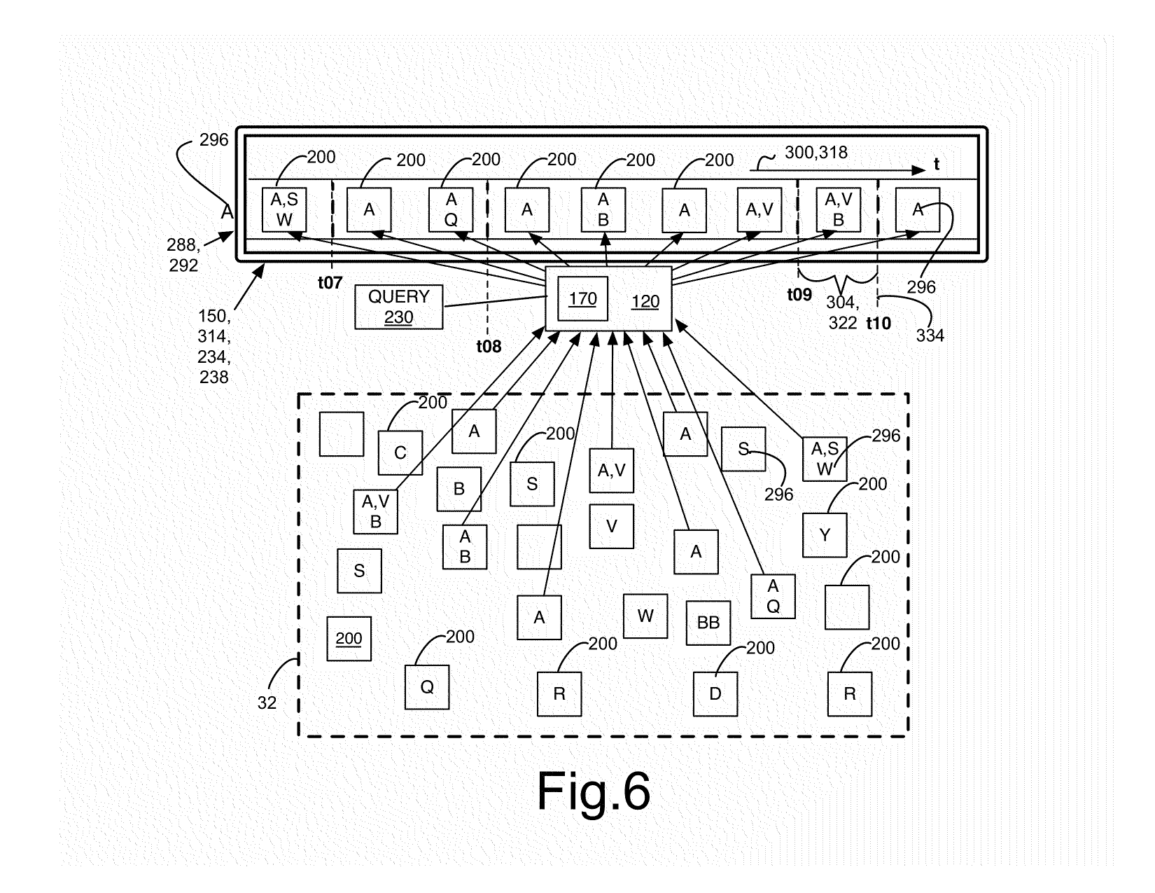

The data elements management module 186 may sort through documents 200 stored in the database 32 and connected to each other via a variety of referencing modes, may apply a filter as specified in a query 230 and may subsequently direct the filtered documents 200 to other modules 174 (this will be shown in FIG. 6). One such module may be an axis-ordering module 206 which may distribute documents 200 filtered by the data elements management module 186 onto an axis-like array 288 or axis 292 (illustrated in FIG. 6) according to a collation function that may be user- or system-specified and analyzed by the computing module 178. An axis 292 or axis-like array 288 is an embodiment of graphical rendering of the functionalities described in the present specification on a device's display 150 that can be embodied as a substantially rectilinear sequence of documents 200 from which a viewer can infer meaning and/or relationships therebetween. An axial distribution 292 of documents 200 is adapted to accommodate and display a single type of documents 200 or, if desirable, more than one type of documents 200, computer files, multimedia contents, user-selectable elements and/or user-selectable menu elements. Generally, an axis 292 is used to graphically group information elements 200 having a commonality. Other functionalities related to axes 292 shall be described in greater detail below.

The axis-ordering module 206 may manage the ordering of single documents 200 and/or several documents 200 assembled into document sets 220 onto one or more axes 292. In addition of managing the collation of documents 200 onto an axis 292, the axis-ordering module 206 may also manage the order of the documents 200 contained within secondary documents sets 232 (not illustrated). The positioning module 210 manages the positioning of documents 200 within axes 240 based on interactions with other modules 174 processing the various elements contained in a query 230. The positioning module 210 is adapted to and may interpret data contained in document sets 228 generated by the data elements management module 186 in relationship to the query 230 to identify a location for a given document set 228 within the collation of an axis 292. Likewise, a visually distinctive features management module 214 is adapted to interpret data contained in documents 200 or document sets 228 generated by the data elements management module 186 in relationship to the query 230 to selectively apply one or more visually distinctive features 284 (not illustrated in this figure) to single documents 200 or document sets 228. Finally, a display management module 218 may, inter alia, manage elements related to the user interface 234, possibly interacting with a graphics card and a monitor 147. The display management module 218 may use a document-rendering module 222 that provides instructions to render specific documents 200, like images, text files, word-processing files, spreadsheet files, presentation files, etc. The document-rendering module 222 may also provide an API to let developers add their own extensions to deliver to renderers other document types.

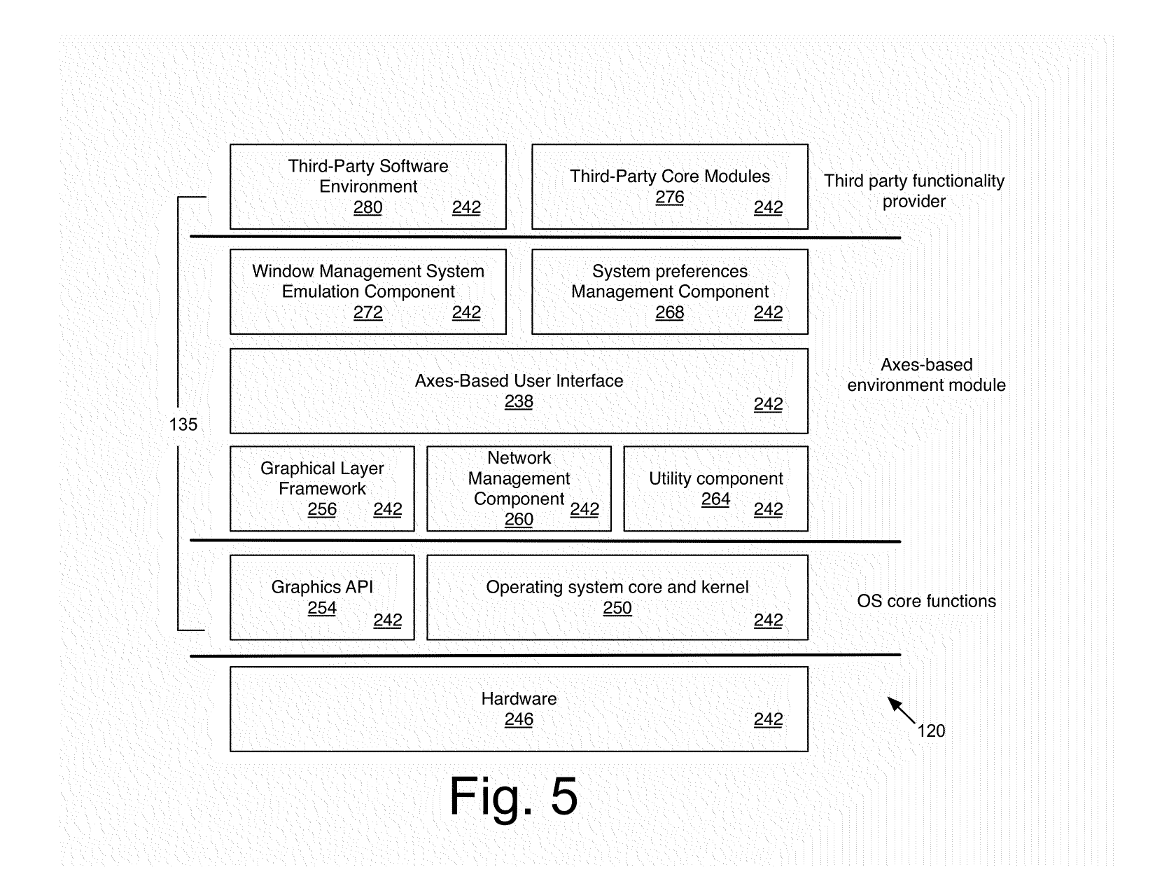

FIG. 5 depicts a computer system 120 comprising an operating system 135 with an integrated axis-based user interface 238. As illustrated in FIG. 5, the axis-based user interface 238 could serve as a desktop environment to manipulate documents 200 (such as files, objects and applications), or could be used as a main operating system 135 user interface 234. One can appreciate a hierarchical description of a computer system 120 and software system 170 with multiple components 242. First, hardware 246 is used to provide users with a physical device 34-48. Second, the axis-based system could be built on top of an existing operating system core and kernel 250, such as, for instance, Unix™ or BSD™. A graphics API 254 like OpenGL® could also be used in order to provide basic graphical capabilities to the system via a video adapter 148.

Multiple core functionalities could be integrated to provide core operating system 135 services. A graphical layer framework component 256 could be built over the graphics API component 254, and could be used to provide complex drawing capabilities. The layer-based graphics layer framework component 256 may also support widget rendering and handling (like buttons, text fields, dialogs, etc.) A network management component 260 could be based on pre-existing network management capabilities in the operating system core and kernel 250. It could serve as a tool to manage an Internet network connection through Ethernet, Bluetooth, Wi-Fi, Modem and other communication channels. A utility component 264 could handle all the other services needed to communicate with the operating system core and kernel 250, providing functionalities such as user login, user authentication, memory, disk-access management, etc. Using these modules, the axis-based user interface 238 would use core functionalities from the graphical layer framework component 256, the network management component 260 and the utility component 264 to provide workspaces 306 comprising multiple axes 292 that display documents 200 (not shown in FIG. 5). The axis-based user interface 238 may also provide more integrated actions, like interface buttons, preview or magnification that may be directly docketed. Another component, a system preferences management component 268 would provide multiple functions needed by the axis-based user interface 238, such as dialogs to manage document insertion, attribute definitions, users, permissions, application configuration, etc. Finally, the operating system 135 may comprise a window management system emulation module 272. This module may be based on an X Window System or X110 and may use other existing client application libraries to provide a large number of applications as well as functionalities to run windowed applications on top of the axis-based user interface 238. To provide other functionalities, third-party application providers could build third-party core modules 276 on top of the axis-based user interface 238 and system preferences management module 268. Third-party application providers could also develop third-party software environments 280 and other applications that could be run using the window management system emulation 272, providing the user with useful applications such as an Internet Browser, Office Business Applications, Multimedia Applications, Games, etc.

The Window Management System Emulation 272 could also offer functions to provide a more axis-based user interface 238 integration, such as, previews, player and editors for the documents 200 displayed in the axis-based user interface 238. For example, a rich text document 200 could use a third-party module 276 or third-party software environment 280 to provide a previewer or media player for the document 200, or a third-party application to integrate a live editor on the axis-based user interface 238.

This computer system 120 could be used, for instance, as a business solution to provide users with an axis-based user interface 238 operating system 135 directly on multiple kinds of devices 34-48 (computers, laptop, tablets, cell phones, etc.). The computer system 120 may also illustratively be used as a business solution to sell preconfigured devices 34-48 with the axis-based user interface 284. Since the operating system 135 has a built-in axis-based user interface 284, the device 34-48 is likely to have a display 150 and other input devices like a keyboard 140, a mouse 142 or a touch-screen interface. The devices 34-48 may not necessarily provide such parts and may be adapted to be used by communicating information about the user interface 240 and input methods with other devices 34-48 (television set, motion sensing input device, computer or tablet over network, cell phone, etc.)

### The Interface

FIG. 6 illustrates the interaction of the computer system 120 and software system 170 with an axis-based graphical user interface 238. An interface program providing a graphical user interface 234 for managing information elements 200 in accordance with an embodiment of the invention is installed on a machine, e.g. a computer system 120 as illustrated in FIG. 3. The interface 234 can be programmed using various programming languages e.g. C++, Java or other suitable programming languages. The programming of these languages is well known in the art and is adapted to be stored on a machine-readable medium and readable therefrom to provide executable instructions to a hardware system. It is believed that a skilled reader in software art is going to recognize this portion of the system that will, therefore, not be further described herein.

The graphical user interface 234 may run through the operating system 135 and the hardware 246 of the computer system 120 or, alternatively, through a network-based system e.g. client-server, and/cloud computing system as exemplified in FIG. 1 and FIG. 2. The interface 234 is adapted to display and manage information elements 200, generally provided on a basis of a query 230, which may be stored in one or many databases 32 (as illustrated in FIG. 6) that might be distributed in a combination of locations (e.g. multiple databases, web, cloud, etc.). Information elements 200 may include computer files, pictures, multimedia content, applications (i.e. computer programs), menu elements, sets of icons and/or other user-selectable elements, all of which shall henceforth be indiscriminately referred to as documents 200 to lighten the text without limiting the scope of the present invention.

An axis-based graphical interface 238 is adapted to graphically structure documents 200 in arrays 288 that arrange the documents 200 in rows and/or columns in a reasonably regular fashion and to allow navigation thereof by the user further to a query 230. The axis-based layout and ordering provide the user with information about the content of each document 200, its meaning and its relationships to the other documents 200 disposed on the axis 292. Navigation tools are provided with the axis-based user interface 238 to allow navigation through the documents 200 of a single axis 292 and of various axes 292 when a plurality of axes 292 is enabled. The display of documents 200 on an array 288, or axis 292, therefore allows contextual management of documents 200 as a flow, or an ongoing rational sequence of documents 200. An axis-based interface 238 thus helps to intuitively display a group of documents 200 and facilitate understanding and managing large sequences of documents 200 bearing a relation.

In a simplified exemplary form, an array 288 may be embodied as an axis of documents 292 (hereinbelow referred to as axis 292 to lighten the text), which groups documents 200 in a single row or column, as illustrated in FIG. 6. An axis 292 can be embodied as a substantially rectilinear arrangement of documents 200 adapted to dispose each document 200 on a straight or curved line. The axis 292 can be embodied as completely straight (rectilinear), slightly curved, substantially curved, circular, angled, following a particular shape or have a consistent shape over which documents 200 are disposed in a reasonably consistent fashion. The exact shape of the axis 292 as well as its disposition can vary—horizontal, vertical or other—in relation to the device's display 150. What matters, inter alia, is that the layout structure of an axis 292 provides a sequence of documents 200 from which a viewer can infer meaning, logical connections, contextual location, and/or relationships.

The axis 292 can be represented as a single axis 292, a double axis 292, or more axes 292. Axes 292 may be independent from one another (using distinct scales, or orderings, henceforth referred to as collation functions 300) or may form a group of axes 310 by sharing the same scale or collation function 300. Also, a document 200, attribute 296 or other property of an element contained in an axis 292 can be selected and used as a logical connector to create an additional axis 292 from an existing axis 292. This subsidiary axis 294 is meant to be temporary in some embodiments, serving as a way to view a specific set of additional documents 200 or highlight certain documents 200 from the original axis 292 without having to alter the entire workspace 306. It may originate from the logical connector document 200 or information element 200 and be disposed in non-parallel fashion thereto. The subsidiary axis's 294 position is preferably orthogonal to the original axis 292. However, the angle may vary. Like axes 292, logically connected axes 294 may be scrollable. More such logically connected axes 2924 can subsequently be created in the same fashion. Navigation among axes 292 and subsidiary axes 294 could be called “relational navigation”.

Axes 292 may be disposed horizontally and/or vertically. Groups of axes 310 may be presented using one of the layouts or combining both. The axes 292 presented in the embodiments below are generally illustrated in the horizontal layout configuration. However, they could, all or in majority, be disposed vertically without departing from the scope of the present disclosure. Other possible graphical layouts of documents 200 might become obvious to a skilled reader in light of the present application and would be considered within the scope of this application.

When only a portion of the axis 292 is visible, a play of zoom, pan and scrolling movements along the axis 292 allows a user to navigate the axis 292 and change the series of documents 200 that are displayed in the display area 314 of the display 150. Scrolling movements can be performed in a variety of ways including but not limited to click-and-drag, pressing on the keys of a keyboard, gesturing to a motion-sensor or on a touch-screen.

Documents 200 might overlap or decrease in size so as to fit or maximize the space available in the display area 314. Selected documents 200 on an axis 292 can be magnified to increase the level of detail shown. Similarly, a small display area 314 could display only one document 200 out of the entire axis 292. The remaining documents 200 would not be shown in the display area 314 but would yet remain at their respective “virtual” position on the axis 292, ready to be displayed upon scrolling the axis 292. In other words, if we consider a mobile platform like a mobile phone having a small display 150, the small display 150 might only allow to efficiently exhibit one document 200 at a time. However, given that the displayed document 200 is part of an axis 292, the other documents 200 on the axis 292 would remain displayable in accordance with their respective position on the axis 292 when the axis is scrolled, navigated, gestured.

The documents 200 are selected to be disposed on the axis 292 on the basis of one or more attributes 296, and are ordered thereon according to a collation function 300, namely an ordered arrangement made by comparison, (e.g. a chronological order adapted to use a time scale 318. The attribute(s) and collation function parameters are specified in a query 230 that may be run by a user or by an automated function of the system. Indeed, each axis 292 groups documents 200 in accordance with, for example, a selected tag, category, keyword, document creator, or other attribute 296 that expresses a characterization of one or more document(s) 200 and that are configurable to represent intrinsic or extrinsic characteristics. The term “attribute” 296 will generally be used throughout the instant specification to lighten the reading of the text and will encompass other document properties or means for establishing commonality or relationships as described above unless otherwise specified.

Attributes 296 may be user-specified or system-specified. Generally, documents 200 bear a plurality of attributes 296 assigned by one or more user(s) (e.g. keyword, subject, project, creator, category, etc.), and a plurality of attributes 296 that are assigned by the system, such as, illustratively, file type, time of creation, number of views, time of last modification, file size, etc. Given the broad range of applicability of the present invention, the attributes 296 that may be assigned by the system and user, as well as the attributes 296 that can be desirable to use in the management of axes 292 might substantially vary from one field or user to another and however remain within the scope of present specification.

The selection of one or more attributes 296 (using Boolean logic for instance) in a query 230 determines which documents 200 will be displayed on the axis 292. If no specific attribute 296 is selected, the axis 292 will display all documents 200 in a default order, like the date of creation thereof. Thus, all documents 200 on the same axis 292 are normally associated with the selected set or combination of attributes 296 that are used as parameters for the axis 292. Third-party data, like publicity or user-targeted information, could also be added to an axis 292, either arbitrarily or according to user information, filtering and/or existing collation of axes 292 without departing from the scope of the present invention.

The documents 200 illustrated in FIG. 6 feature attributes 296 individually represented by a capital letter thereon, or none, in which case the documents 200 are left blank. Letter attributes 296 are used in the present application for illustrative purposes only while letter attributes are theoretically possible. More descriptive attributes 296 such as those described above are used in embodiments of the present invention. As is shown in FIG. 6, any document 200 can simultaneously feature multiple attributes 296, some user-specified and others system-specified. In fact, a preferred embodiment of the invention assigns a plurality of attributes 296 to every document 200. Other documents 200 illustrated on FIG. 6 are blank, or without any associated attribute 296, illustrating documents that could theoretically not be assigned any attribute 296, but that could nonetheless be created and found in a query 230 (e.g. a query 230 that would select all documents 200 contained in the database 32).

The query 230 in FIG. 6 here illustratively filters and selects documents 200 from the database 32 based on attribute 296 ‘A’ for display on the axis 292. FIG. 6 further illustrates that the documents 200 selected from the database 32 by the query 230 are placed on the axis 292 in chronological order 318, another parameter that could be specified in the query 230. Indeed, an axis 292 also generally disposes the documents 200 resulting from the query 230 in accordance with a specified order or collation function 300, (e.g. chronological order, alphabetical order, statistical order, increasing file size, etc.). A collation function 300 might include dividing the axis 292 into successive collation units 304 (e.g. time units 322 in the case of a chronological order, which can illustratively be hours, days, months, years, etc.). A collation function 300 would thus dispose each document 200 along the axis 292 according to the value of a specified attribute 296 in relation to the collation units 304 of the axis 292 and the other documents 200 of the selected document set 228. Among collation functions 300, a chronological distribution of documents 200 on a time scale 318 is used in most embodiments of our work because of its intuitiveness (because any action or event takes place at a specific time and usually in sequence with other events or actions). While an axis 292 disposing documents in random fashion is also contemplated within the scope of the present specification, axes 292 disposing documents 200 according to a collation function 300 are illustrated embodiments because of the usefulness of ordering documents 200.

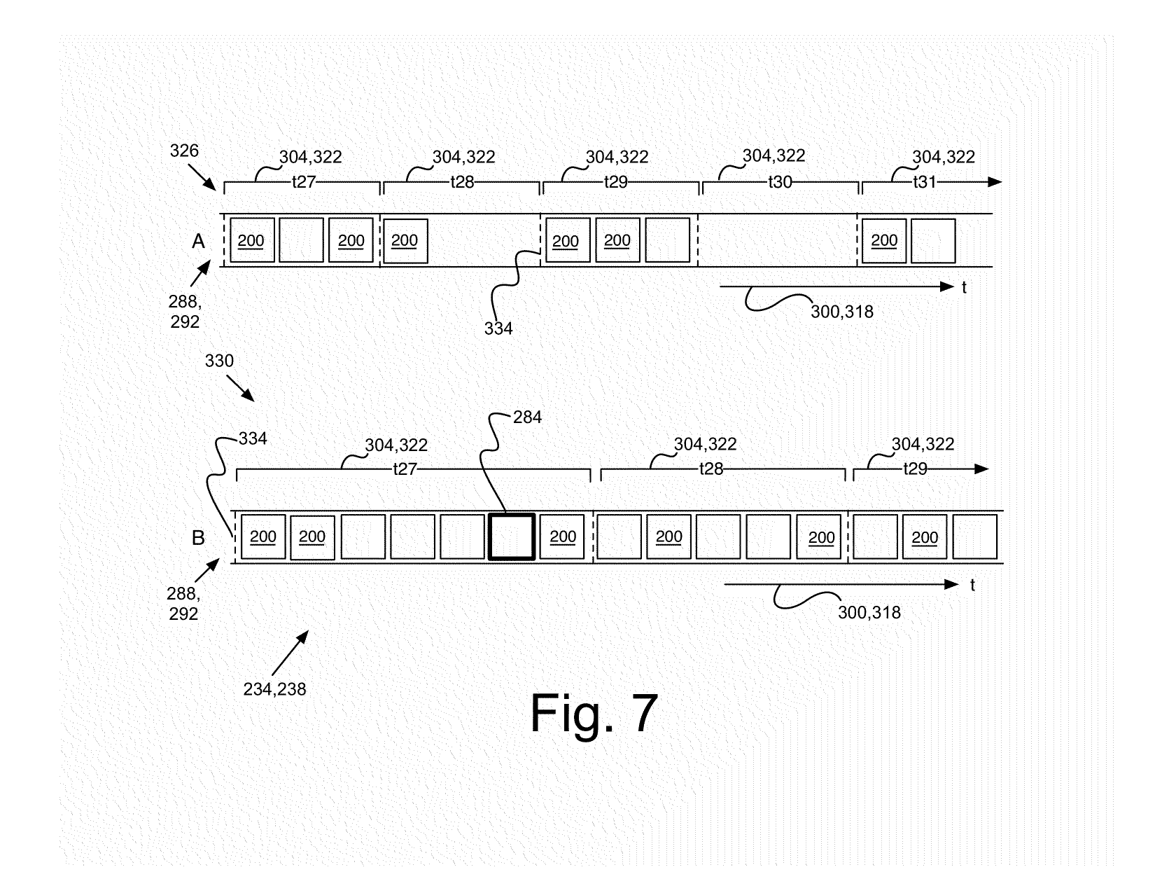

An axis 292 or a group of axes 310 may be embodied in a linear configuration 326 or a non-linear configuration 330. Both configurations are illustrated in FIG. 7 in a generic example. As can be appreciated from FIG. 7, a linear configuration 326 displays collation units 304 of the same graphical longitudinal size regardless of the number of documents 200 contained in each collation unit 304. The size of the documents 200 located within a given collation unit 304 can optionally be adjusted in accordance with the number of documents 200 located therein. For instance, documents 200 will be larger if there are few documents 200 in the collation unit 304 and smaller if many documents 200 are found therein. Alternatively, the documents 200 can remain the same size and can overlap, or be stacked, when their quantity exceeds the available space. Another possible way of making large numbers of documents 200 fit into a fixed-size collation unit 304 is to equip the collation unit 304 with a scroll bar allowing the user to navigate the collation unit 304 to reveal hidden documents 200. This also means that documents 200 in a linear configuration 326 may be displayed as an uneven sequence from a graphical point of view. Ultimately, a collation unit 304 in a linear configuration containing no document will appear as empty, or as a blank space on the display 150, but will still be the same size as the other collation units 304 of the axis 292.

Conversely, the non-linear configuration 330 displays collation units 304 of uneven longitudinal sizes because an even distribution of documents 200 along the axis 292 prevails over the linearity of the collation. In other words, document 200 size and a constant flow of documents 200 along the axis 292 are given primacy over having collation units 304 of equal graphical size. This provides a more efficient use of the space on the axes 292, but may provide less meaning to illustrate an evolution along time.

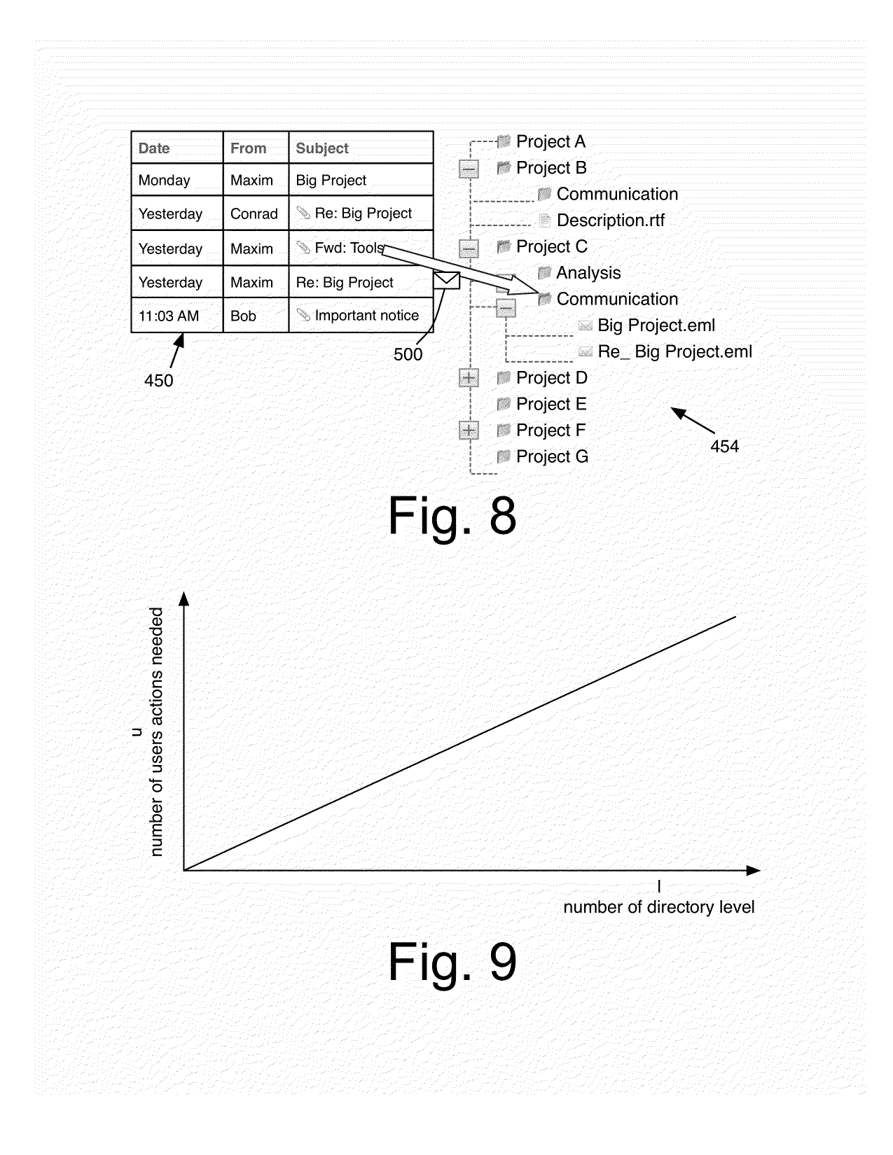

Moving now to the invention. Typically, although a user could still opt for a basic single-level format, the filing of an e-mail 500 will be done from a list 450 into a tree-based, multi-level structure 454, as shown in FIG. 8.

As for any typical tree-based file storage, efficiency, and ultimately ease of retrieval of the information, depends on the rigor and discipline of the storage procedure, and remains a time-consuming exercise: the more precise and logical the storage/retrieval is desired to be, the more steps or actions from the user are typically needed. The number of actions is typically proportional to the number of levels in a tree-based filing structure, with each change of level a potential storage error or retrieval “false route”. FIG. 9 shows a graph of that number-of-levels to actions relation, with the number of directory levels I on the x-axis and the resulting numbers of needed user actions u on the y-axis.

The situation becomes more complex with the fact that e-mails very often come with “attachments”: files, such as text documents or spreadsheets, which are attached (and therefore sent simultaneously) to the e-mail 500.

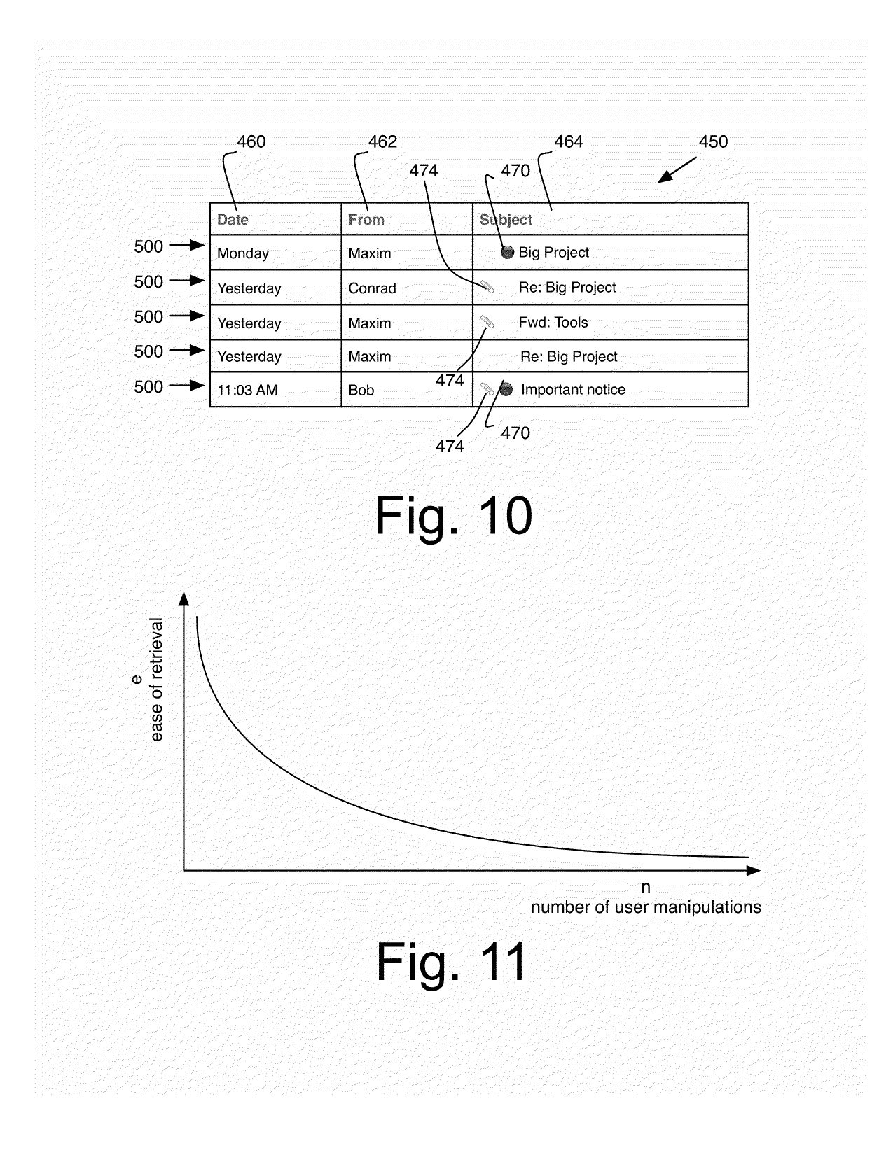

E-mail software systems will typically graphically show that an e-mail 500 has attachment(s), by generally by adding some sort of “flag” by the e-mail subject in a list of e-mails as shown on FIG. 10, where column 464 are five e-mails 500 from a list, each that may have a pictogram showing its unread status 470. E-mails show flags 474 indicating that there are attachments. The attachments are generally accessible only if the e-mail 500 is opened (or at least “pointed to” in some case), and not directly from the list level.

If a user chooses to file/archive an e-mail 500, the “trace” to such attachments becomes even harder to follow: the more manipulations are done to store the “carrier” e-mail 500, the harder the retrieval of the attachment(s) becomes, as shown by FIG. 11, where the number of user manipulations n is shown on the x-axis, and the ease of retrieval e is shown on the y-axis.

The more levels a tree-based e-mail storage structure 454 has, the deeper the attachments are buried within it: the user wishing to retrieve such an attachment has to base his her research on some rather vague information if he/she can even remember such things as who had sent the “carrier” e-mail or the approximate date on which the “carrier” e-mail 500 has been received. This can be quite a non-efficient and frustrating experience.

An alternate method attachment is object pasting, where information, like a table or an image, is actually pasted onto the text of an e-mail 500: such attachments are even harder to retrieve, as non-opened e-mails 500 (from a list) may not even show any attachment “flags” 474 (often a paperclip icon).

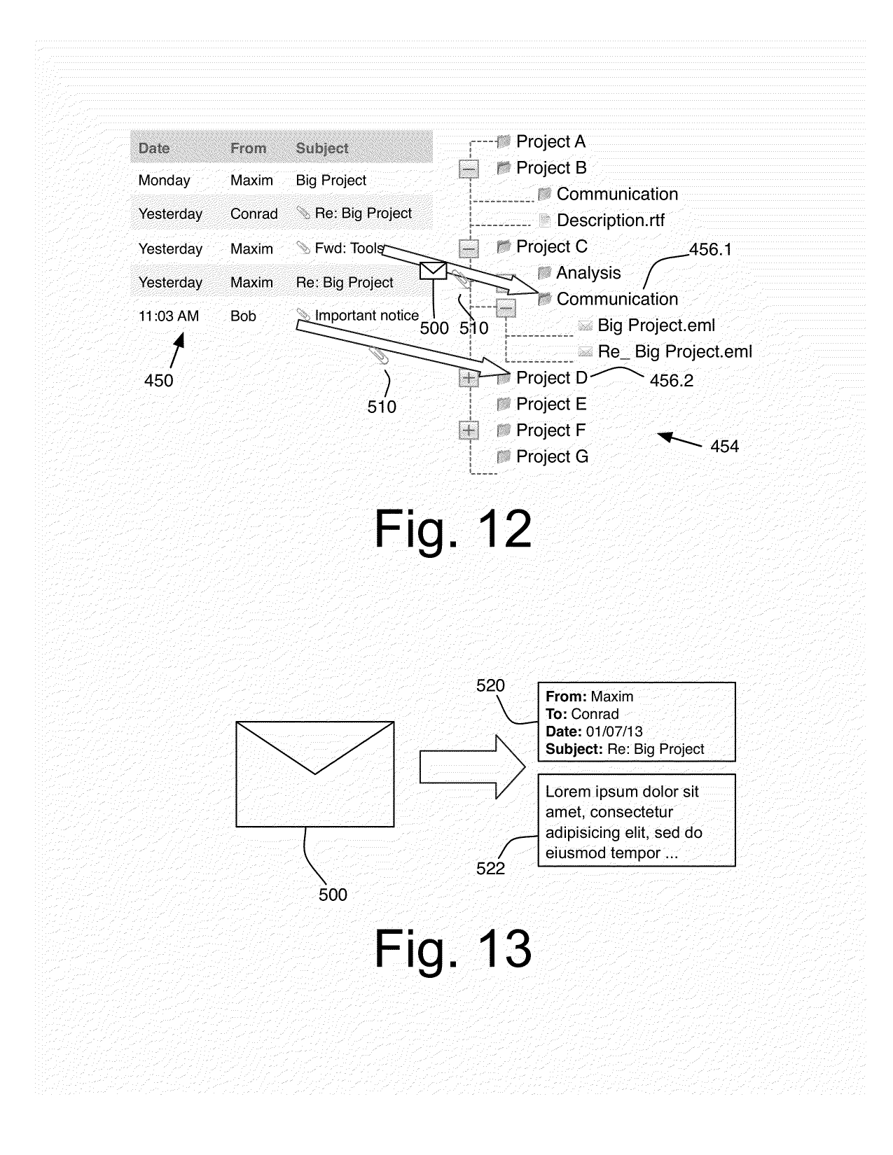

E-mail software systems typically offer the user the option of “saving” attachments: a copy of the attached file(s) can be stored by the user within his/her tree-based document storage structure 454, which brings up once again the previously-mentioned rigor and discipline challenges. This also creates a duplicate of the “attached” files, thus doubling the memory space used. This process is shown on FIG. 12, where the attachment 510 is now stored with its carrier e-mail e in the e-mail storage structure location 456.1 and as a stand-alone document in the document storage structure location 456.2.

An e-mail is basically constituted of two main building blocks: 1) a group of identifiers such as date, to/from information, size, etc . . . which typically appear both in “list” mode 450 and when the e-mail is opened (the “read” mode) and 2) the body. This is shown on FIG. 13, where the e-mail e has identifiers 520 and body 522.

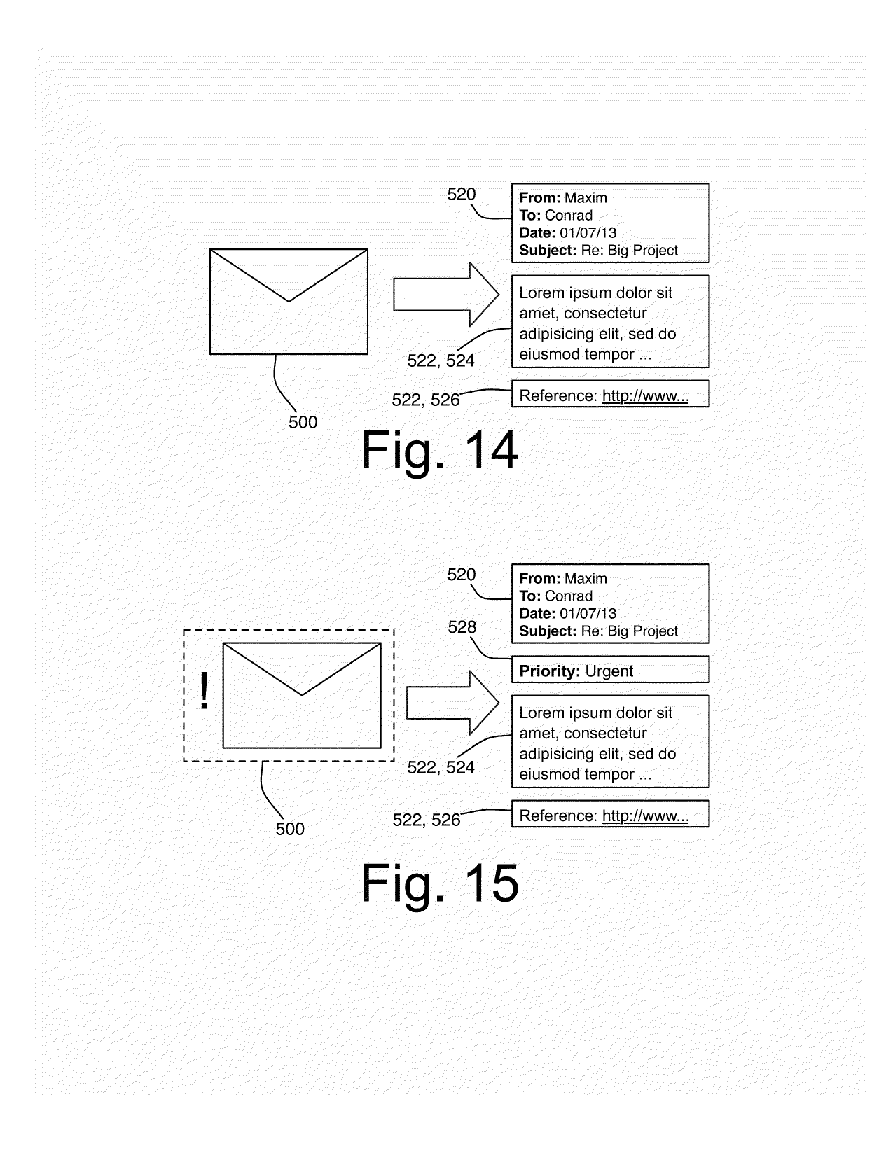

As previously mentioned, the body may contain text and/or “pasted” objects: this is shown on FIG. 14, where an e-mail 500 has identifiers 520, and body sub-components 524 (body text) and 526 (body objects).

An e-mail may also contain optional features, like an urgency level or follow-up flags: these are typically shown as icons that appear when in list mode; this is shown on FIG. 15, where an e-mail e has identifiers 520, body sub-components 522 and features 528.

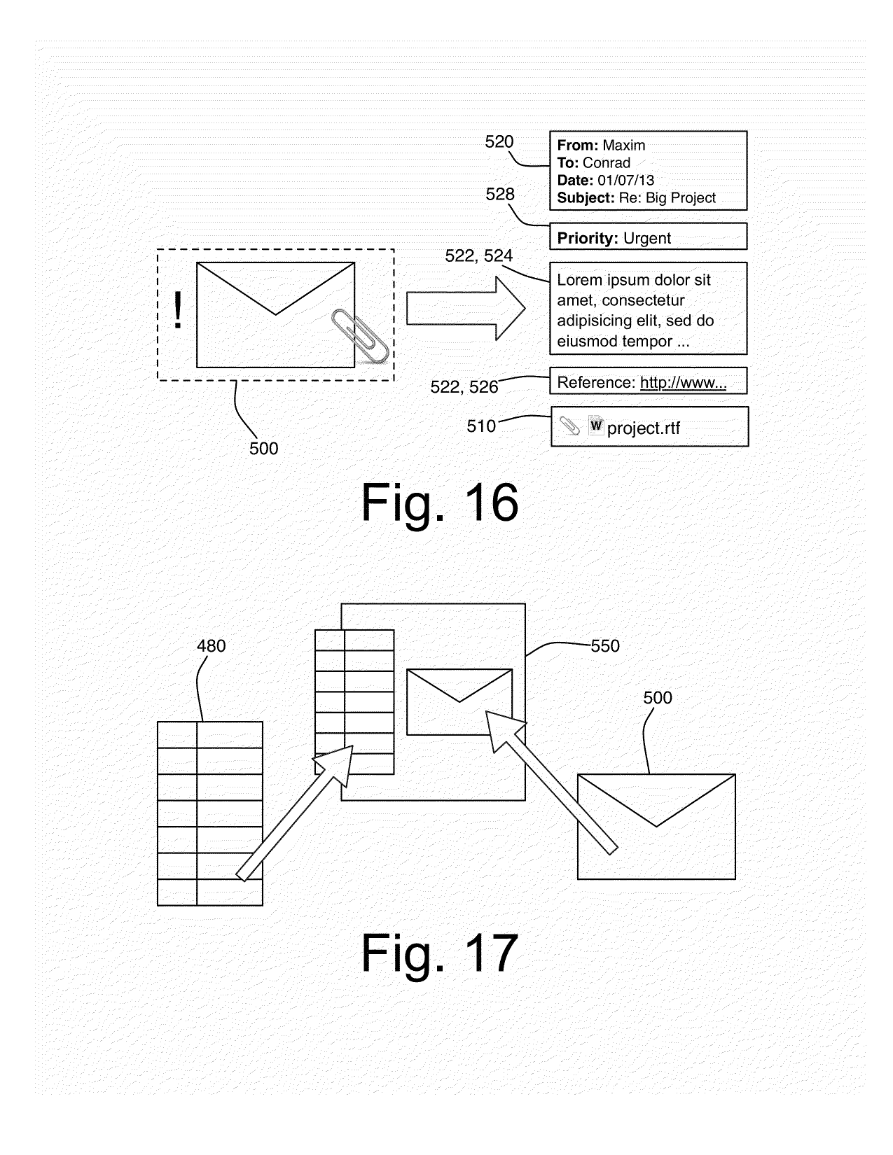

Following the same building block logic, an e-mail with an attachment would therefore have a supplementary block: the attachment 510 itself. This is shown on FIG. 16, where an e-mail e has identifiers 520, body sub-components 522, features 528 and attachment 510.

The above text describes the typical weaknesses of the current e-mail software systems, when it comes to the storage of the information, especially when e-mails 500 become the carriers for attachments:
Efficiency of the storage and retrieval of e-mails 500 is intrinsically linked to the rigor and discipline of the user as in any tree-based storage structure 454;
Storage of attachments 510 requires separate, time-consuming actions;
Distinct storage of a “carrier” e-mail 500 and its attachment(s) 510 creates two distinct attachment storage locations 456, thus doubling the memory space needed.

An embodiment of the invention proposes an alternative to the usual tree-based filing of an e-mail, where the e-mail is considered as an information element 200 that has intrinsic and extrinsic (user-defined) properties, referred to as “attributes” 296. The system-allocated, intrinsic attributes show some similarities with the previously described “identifiers”; on the other hand, the extrinsic ones are attributes allocated to the information element to allow subsequent storage and filing of the e-mail 500 without altering its basic content, format or location. FIG. 17 shows that user action where an e-mail 500 is “transformed” into an information element 550 by the allocation of attribute list 480.

Such manipulations then allows searching and retrieving of the e-mail based on its attributes 296, and not on the rigor with which a tree-based storage structure 454 has been built or followed.

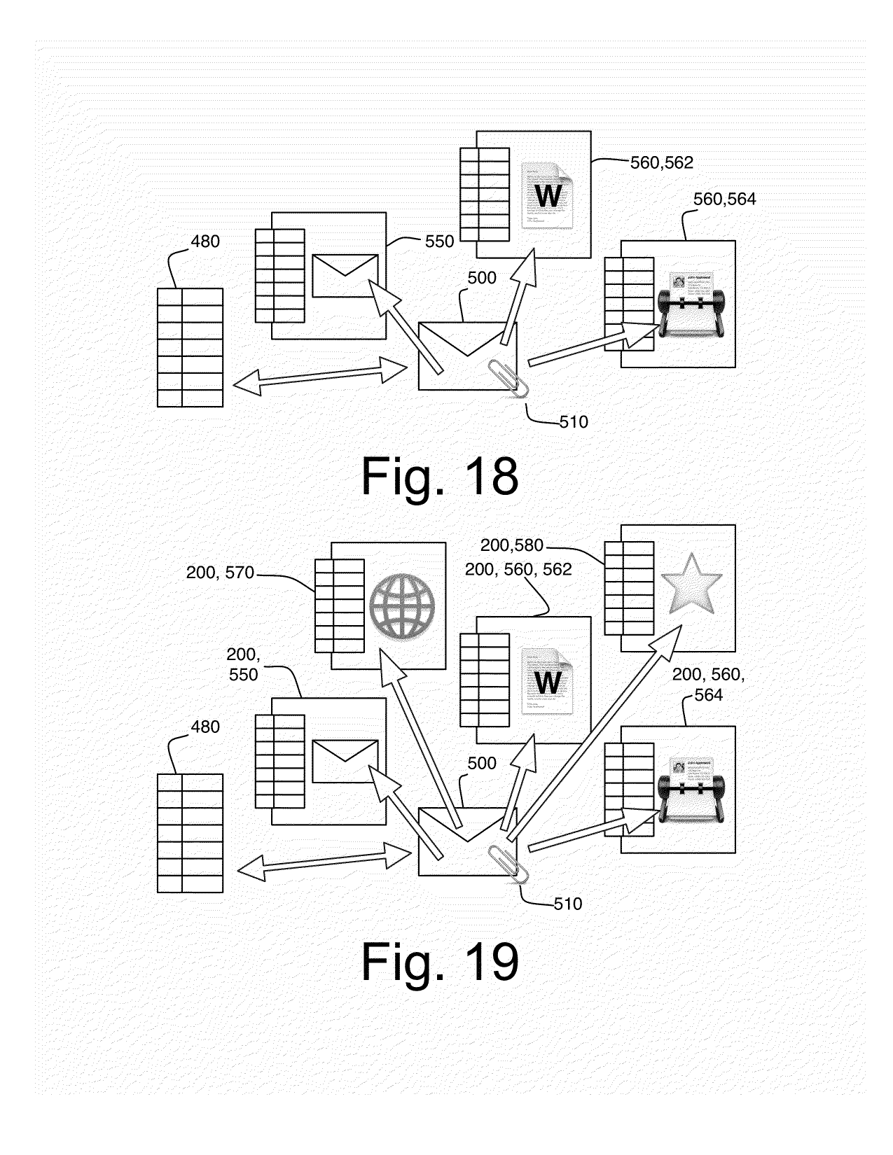

In another embodiment of the invention, a significant gain in efficiency can be obtained by having the extrinsic attributes 296 of the “carrier” e-mail information element automatically, without added user action, allocated to the attachment(s) 510 of the “carrier” e-mail 500. Those attachments 510 would then become linked to specific information elements 200 and would therefore become searchable and easily retrievable in their own right, and without the previously mentioned memory space doubling drawback. This is shown on FIG. 18, where an e-mail 500, containing two attachments, is converted into information elements 550, 562 and 564 with the allocation of attribute list 480. The attributes from information elements 550, 562 and 564 may be a little different one from another, depending on the context.

A further gain in efficiency and cohesiveness can be obtained by another embodiment of the invention, by having the extrinsic attributes of the “carrier” e-mail 500 allocated to the body content, whether it is made of text or pasted objects: specific body sub-components would then be stored (thus becoming searchable and retrievable) as information elements 200, regardless of their link with the carrier e-mail 500 and without the previously described memory space doubling issue. This is shown on FIG. 19, where an e-mail 500, containing two attachments 510, is converted into information elements 550, 560, 570 and 580 with the allocation of attribute list 480.

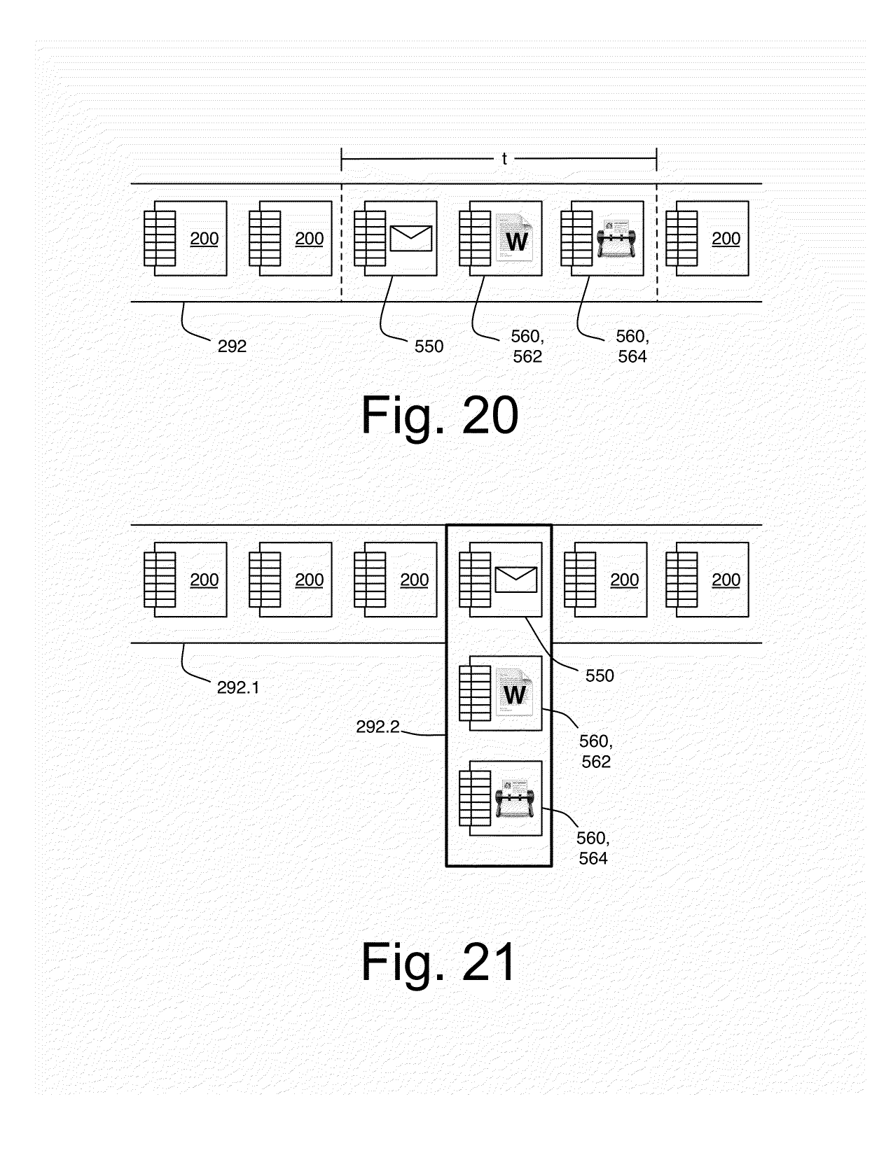

The use of an axes-based graphical display 238 of the information elements would allow simultaneous display of the information elements for the “carrier” e-mail 500 and its attachments 510; this is shown on FIG. 20 where the information elements 550 (for the carrier e-mail), 562 (for the first attachment) and 564 (for the second attachment) are all shown on the same axis 292, as having been inserted during the same time period t.

Alternatively, and using the same graphical interface 238, a search based on the attributes of the carrier e-mail 500 would lead to the display of the search results on a second axis 292.2, where the information elements 550 (for the carrier e-mail), 562 (for the first attachment) and 564 (for the second attachment) will appear, as shown on FIG. 21. This second axis may be shown automatically, or after an action from the user. In FIG. 21, the carrier e-mail 550 that was part of the first axis 292.1, so it appears juxtaposed over it and the second axis 292.2 is disposed perpendicular. The interface may use other disposition of the second axis 292.2.

In an another embodiment of the present invention, the above-mentioned reasoning can be applied to calendar/scheduling software, often a bi-product of e-mail software systems.

Calendar events (or “meeting requests”) in such software systems show clear similarities with e-mails 500, having intrinsic attributes 296 such as date and time, location and participants, but also body text 524 and/or pasted objects 526 as well as attachments 510 such as an agenda or presentation material.

Calendar events aren't typically stored specifically by the user, they generally remain in his/her agenda until the latter is “purged” for server memory space reasons, which then leads to the loss of the body and all attachments.

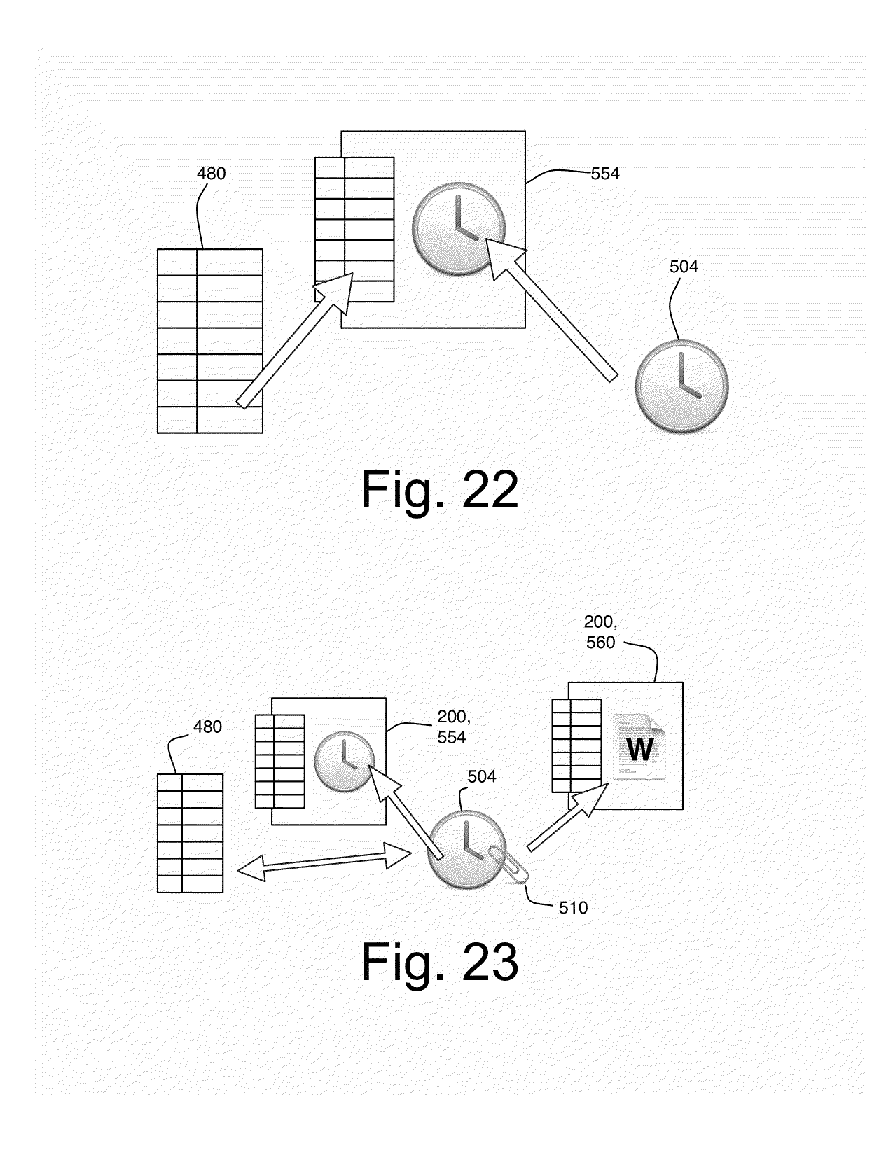

FIG. 22 shows a user action where a calendar event 504 is “transformed” into an information element 554 by the allocation of attributes 480. Such manipulations then allow searching and retrieving of the calendar event based on its attributes 296.

In another embodiment of the invention, a significant gain in efficiency can be obtained by having the extrinsic attributes 296 of the calendar event information element automatically, without added user action, allocated to the attachment(s) 510 of the calendar event. Those attachments 510 would then become linked to specific information elements 200 and would therefore become searchable and easily retrievable in their own right, and without the previously mentioned memory space doubling drawback. This is shown on FIG. 23, where a calendar event 504, containing an attachment 510, is converted into information elements 554 and 560 with the allocation of attribute list 480.

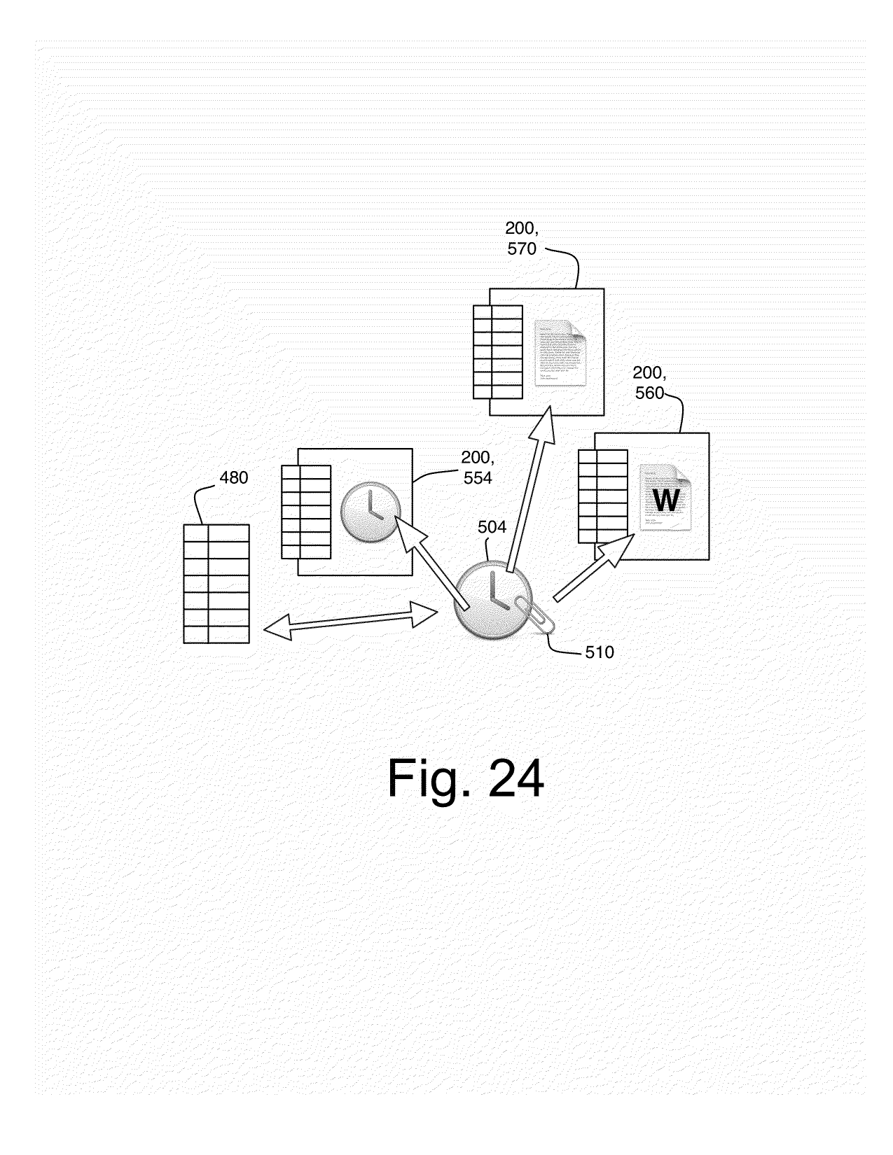

A further gain in efficiency and cohesiveness can be obtained by another embodiment of the invention, by having the extrinsic attributes 296 of the calendar event allocated to the body content 522, whether it is made of text 524 or pasted objects 526: specific body sub-components would then be stored (thus becoming searchable and retrievable) as information elements 200, regardless of their scheduling software link with the calendar event and without the previously described memory space doubling issue. This is shown on FIG. 24, where a calendar event 504, containing an attachment 510, is converted into information elements 554, 560, 570, with the allocation of attribute list 480.

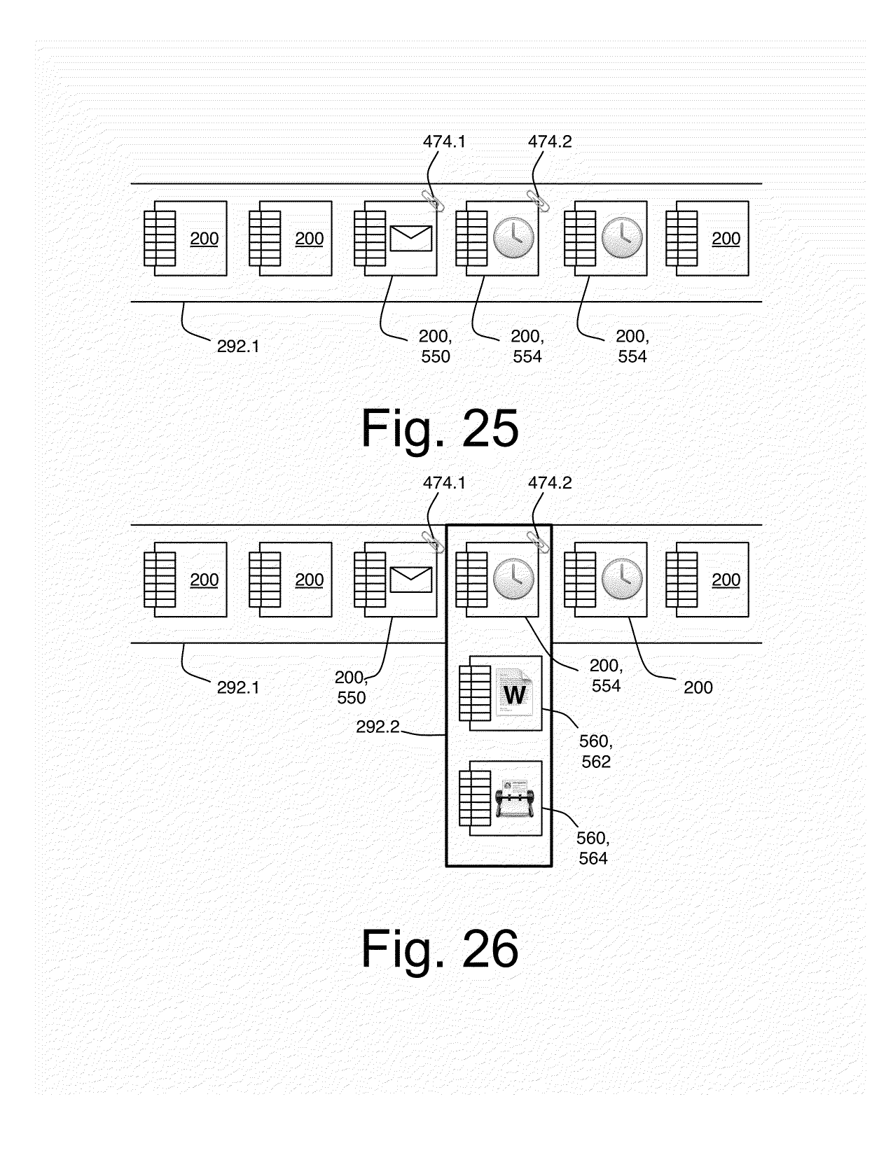

FIG. 25 shows another embodiment of the invention, the axes-based graphical interface may display simultaneous information element 200 on one axis 292 mixed objects, such as documents, e-mails 550 and calendar events 554.

Another embodiment can be seen in FIG. 25, where two documents 200 may have a special marker (or flag) 474.1 and 474.2 to let the user know of the existence of one or more attachments associated with the related information element 200. This may be used when the document has attachment, but those are not displayed on the axis 292.

FIG. 26 describes the display of a second axis 292.2 that is associated with a parent document 554 that may be the result of an action from the user. The second axis 292.2 shows the attachment information elements 560 associated with the calendar event 554. This second axis 292.2 may be defined by a search on the calendar event carrier attribute.

While showing the second axis with the attachments 560, the attachment flag 474.2 is shown over the associated information element 554, but may also be hidden when the second axis is shown over the information document 200.

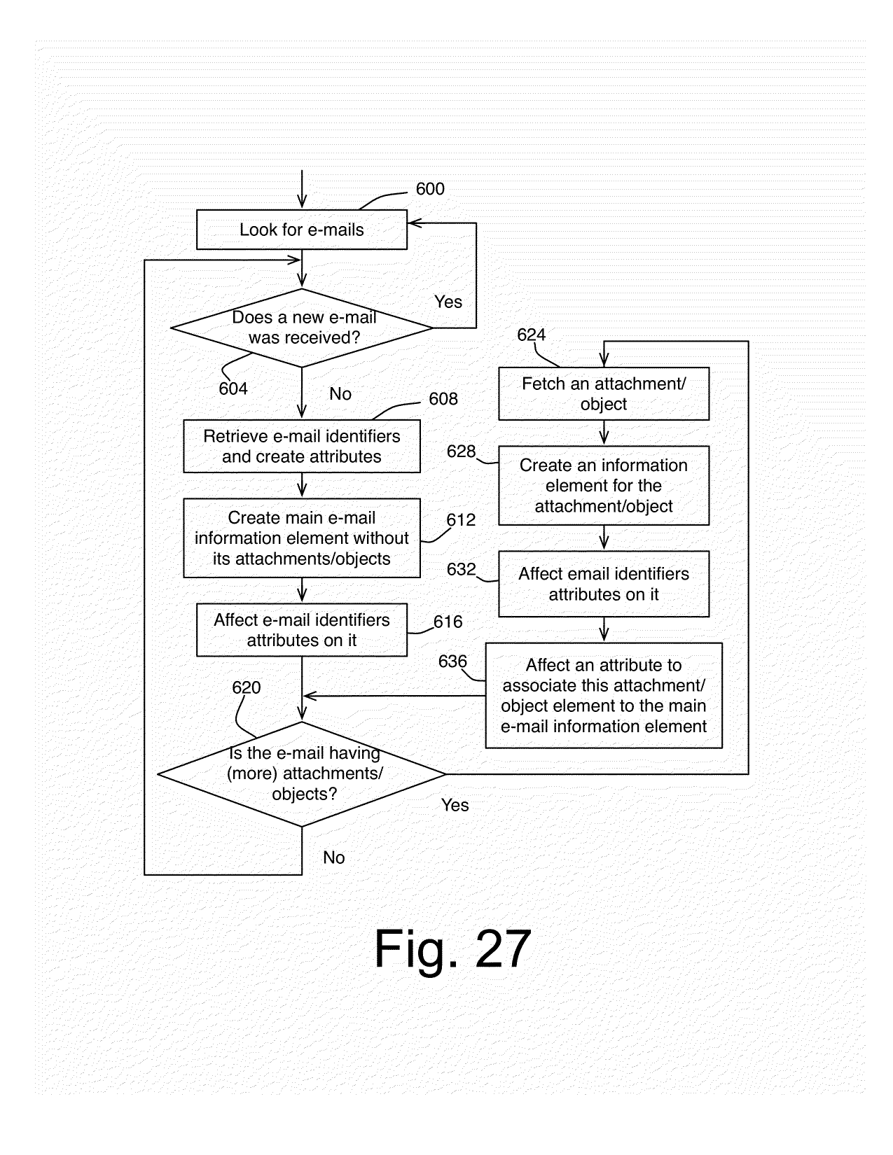

FIG. 27 is a flow chart describing the method of separating an e-mail from their attachments and associating attributes on them. The processing step 600 look up for new e-mails while the decision 604 provides a loop for the verification of the new e-mail. Once a new e-mail is fetched, the system retrieves and creates attributes on e-mails identifiers in processing step 608. Then, in processing step 612 the system creates the main information element representing the e-mail without its attachments and other special body objects. A body object may be considered special if the system decides it should need to be separated from the original information element. In processing step 616, the system may then affect the e-mail identifiers attributes on the information element.

The decision 620 provides a loop to create separated information element for each attachment and other special body objects. For each of them, the system fetches them in processing step 624. After that, it creates a distinct information element for the attachment or special object, in processing step 628. Then, it may affects e-mail identifiers attributes on it, that would provide extrinsic information, by example, who send that document, when, on what subject, etc. This is done in processing step 632. Finally, processing step 636 affects an attribute to associate this attachment or special object information element to the information element representing the e-mail. This may be done by using an unique identifier comprise in the main e-mail information element, such as a database key field, an integer, an UUID. Once processing step 636 is done, the decision 620 looks for other attachments and objects. Once finished, the system goes back to its initial loop 600 and 604, looking for other received e-mails.

The description and the drawings that are presented above are meant to be illustrative of the present invention. They are not meant to be limiting of the scope of the present invention. Modifications to the embodiments described may be made without departing from the present invention, the scope of which is defined by the following claims:

What is claimed is:

1. A method of associating email and attachments with attributes, the method comprising:
associating a first attribute with an email and at least one attachment associated therewith;
wherein the attribute associated with the email is also associated with the at least one attachment to establish a commonality between the email and the at least one attachment.

2. The method of claim 1, further comprising
associating a second attribute with the email; and
associating a third attribute with the at least one attachment.

3. The method of claim 2, further comprising:
selecting the second attribute; and
displaying documents, and the email, associated with the selected second attribute in a generally rectilinear fashion.

4. The method of claim 3, further comprising:
displaying the at least one attachment on a basis of an action performed by a user in respect with the displayed email.

5. The method of claim 4, wherein the at least one attachment is displayable in a generally rectilinear fashion associated with the third attribute.

6. The method of claim 5, wherein the at least one attachment is adapted to be displayable on an attachments axis graphically associated with the email to which it relates.

7. The method of claim 5, wherein the at least one attachment is adapted to be displayable on an attachments axis graphically dissociated from the email to which it relates.

8. A method of separating an email from its attachment, the method comprising:
receiving an email with at least one attachment;
associating an attribute with the email and the at least one attachment;
dissociating the at least one attachment from the email;
displaying the email without the at least one attachment; and
displaying the at least one attachment in graphical relation with the email on a basis of an action performed by a user.

9. The method of claim 8, wherein the email is displayed with an attachment notification element when the email is displayed without the at least one attachment.

10. The method of claim 8, wherein the dissociation of the at least one attachment includes the creation of a distinct information element associated with the at least one attachment.

11. The method of claim 8, wherein the email is displayed on a first axis of documents and the at least one attachment is displayable on a second axis of documents.

12. The method of claim 11, wherein the second axis of documents is displayable in graphical relationship with the email on the first axis of documents.

13. The method of claim 12, wherein the second axis of documents is displayable abutting or intersecting the email on the first axis of documents.

14. A non-transitory computer-readable medium having stored thereon computer-readable instructions that, when executed by a computer, cause the computer to perform operations of separating an email from its attachment, the operations comprising:
receiving an email with at least one attachment;
associating an attribute with the email and the at least one attachment;
dissociating the at least one attachment from the email;
displaying the email without the at least one attachment; and
displaying the at least one attachment in graphical relation with the email on a basis of an action performed by a user.

15. The non-transitory computer-readable medium of claim 14, wherein the email is displayed with an attachment notification element when the email is displayed without the at least one attachment.

16. The non-transitory computer-readable medium of claim 14, wherein the dissociation of the at least one attachment includes the creation of a distinct information element associated with the at least one attachment.

17. The non-transitory computer-readable medium of claim 14, wherein the email is displayed on a first axis of documents and the at least one attachment is displayable on a second axis of documents.

18. The non-transitory computer-readable medium of claim 17, wherein the second axis of documents is displayable in graphical relationship with the email on the first axis of documents.

19. The non-transitory computer-readable medium of claim 18, wherein the second axis of documents is displayable abutting or intersecting the email on the first axis of documents.
